(19) United States
(12) Patent Application Publication
(10) Pub. No.: US 2025/0199563 A1
(43) Pub. Date: Jun. 19, 2025

(54) MULTIPLE ENDPOINT FINE SYNCHRONIZATION OF ARBITRARY CLOCK DOMAINS

(71) Applicant: Intel Corporation, Santa Clara, CA (US)

(72) Inventors: Shelby G. ROLLINS, Hillsboro, OR (US); Evan FLEDELL, Portland, OR (US); Preethi SRINIVAS, Redondo Beach, CA (US)

(21) Appl. No.: 18/544,225

(22) Filed: Dec. 18, 2023

(51) Int. Cl. G06F 1/08; G06F 1/10

(52) U.S. Cl. CPC G06F 1/08; G06F 1/10

(57) ABSTRACT

Methods and apparatus for multiple endpoint fine synchronization of arbitrary clock domains. An example apparatus (test module) includes a Field Programmable Gate Array (FPGA) or Application Specific Integrated Circuit (ASIC) having a target frequency of operation for input-out (IO) signals and programmable clock generation circuitry to generate a plurality of programmable clock signals including a reference clock (RefClk) signal that is correct for the target frequency of operation of IO signals. The module includes a plurality of synchronous devices such as pin electronic (PE) blocks that are configured to receive respective clock signals output from the programmable clock generation circuitry and generate and receive a respective set of IO signals associated with a respective clock domain. The respective sets of IO signals generated and received by the plurality of PE blocks are synchronized across the respective clock domains. One or modules may be implemented on instrument boards in a test system under which the IO signals across all clock domains are synchronized.

### BACKGROUND INFORMATION

Some Application Specific Integrated Circuit (ASIC) and Field Programmable Gate Array (FPGA) based systems require high resolution time domain alignment across a large number of devices. Getting many FPGAs and associated integrated circuits on printed circuit boards (PCBs) to act together synchronously and deterministically phase aligned can be very difficult.

Modern FPGAs and ASICs have introduced new problems into the traditional space as high performance Input-Output devices (IOs) require internal Phase-Lock Loops (PLLs) to meet ever growing performance requirements demanded by DRAM and Transceiver interfaces. Simpler ASIC/FPGAs IO IPs (Intellectual Property devices/blocks) allowed the injection of external clocks to control serializers present. One known solution for performing tight synchronization was to first gate the external clock to the IO at the origination of the clock source, typically a direct digital synthesis chip (DDS). Resets on system components would be applied and data pipelines filled up to the IO. Once all system components and data required were ready, the clock would be deterministically ungated and the first edge at the IO would create the new synchronized interface. Any deltas in time-of-flight path delays would be known and compensated for by known mechanisms. This solution scaled to an arbitrary set of clocks defined. Even asynchronous clocks could start at the same time due to the alignment of the clock gating itself.

This entire solution space is unviable with modern PLL-based ASIC/FPGAs as the PLL controlling the serializer will lose lock as soon as the clock is gated, destroying any chance at deterministic phase alignment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a system diagram of a test module, according to one embodiment;

FIG. 2 is a schematic diagram of a pin electronics (PE) block or ASIC; according to one embodiment;

FIG. 3 is a system diagram of a test module illustrating further details of the test module of FIG. 1, according to one embodiment;

FIG. 3a is a schematic diagram illustrating further details of the three-stage clock path implemented in the test module of FIG. 3, according to one embodiment;

FIG. 4 is a system diagram of a test system, according to one embodiment;

FIG. 5 shows some example signal routing/processing paths that are used for a plurality of test modules;

FIG. 6 is a flowchart illustrating operations performed to during a sync start sequence, according to one embodiment;

FIG. 7 is a flowchart illustrating operations performed to calibrate the PE↔FPGA IO interfaces, according to one embodiment;

FIG. 8 is a flowchart illustrating operations performed to implement the DDS hop to a factor of the GCD period in block 608 of FIG. 6, according to one embodiment;

FIG. 9 is a flowchart illustrating operations performed to implement the data sync across the system operation of block 610 of FIG. 6, according to one embodiment;

FIG. 10 a flowchart illustrating operations used to program and train various clock signals, according to one embodiment;

FIG. 11 a flowchart illustrating further details for programming the non-RefClk clock source outputs to hop to the GCD from block 1010 in FIG. 10, according to one embodiment;

FIG. 12 a flowchart illustrating operations to obtain a GCD signal, according to one embodiment; and

FIG. 13 is a schematic diagram of a test system, according to one embodiment.

### DETAILED DESCRIPTION

Embodiments of methods and apparatus for multiple endpoint fine synchronization of arbitrary clock domains are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the solutions described and illustrated by the embodiments herein, DDS technology, software, and FPGA IP are leveraged to create greatest common divisor (GCD) clock domains and soft train digital interfaces in pre-synchronization steps to then enable high resolution synchronization (performance limited by worst case of time-of-flight based calibration or DDS resolution solution spaces). The novel solution space uses software algorithms to determine a GCD of all related clock periods of interest. A separate DDS output is programmed to provide each FPGA IO PLL (or ASIC IO PLL) with a related reference clock (RefClk) that is correct for the associated final target frequency of operation. Once established this will keep the PLL alive and locked.

All non-RefClk DDS outputs are then programmed to hop to the GCD. Knowledge of the GCD divider to the individual FPGA instance is provided to each FPGA. The GCD is then recreated inside the FPGA through training sequence via the mirrored set of programmable counters inside. GCDs can end up being very low frequency. Since the DDS creates a sinewave environment the appreciable change of effective edge rates synthesized will cause clock buffer chips and clock inputs in downstream devices to see large delay offsets due to simple DC offset errors relative to any buffer amplifier inputs. A method devised to work through this error is to train the GCD one divisor factor at a time, hopping to a lower and lower frequency. At each new lower frequency, the FPGA will establish a wider window to look for the new sine wave edge but not so wide as to include any possible aliases range relative to the previous step. The final position is calculated by combining all the window results together. The GCD channel is then hopped back to the final target non-GCD frequency.

Running the clock for some small amount of time post GCD rate is used to rebalance the clock electrical path at the final frequency. During this time running at full data rate, the FPGA trains all interfaces to the synchronous downstream targets at the final speed. Data pipelines can be filled during the training process. When all training is complete, one lead FPGA signals the others to start content delivery on the next internal GCD edge at a time sufficient for all listeners to receive it by the next GCD edge. Each FPGA will latch the event until the internally generated GCD edge is seen and then begin delivery of content to downstream targets.

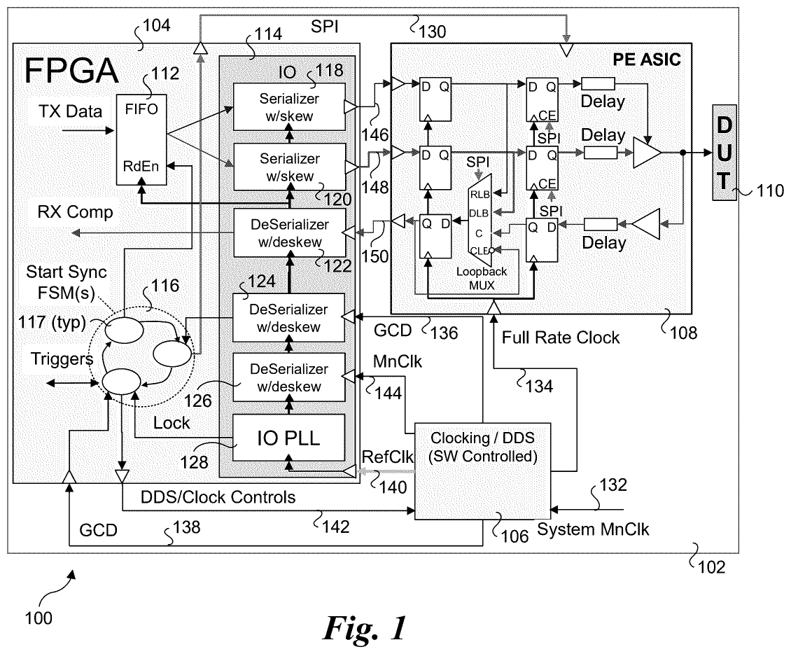

FIG. 1 shows a system diagram of a test module 100, according to one embodiment. Test module 100 includes a board 102 on which various components and circuitry are installed/implemented including an FPGA 104, a software-controlled clocking/DSS block 106, and a Pin Electronics (PE) ASIC 108 that emulates various IO standards at the DUT interface for a DUT 110, including a clock signal. FPGA 104 includes a FIFO 112, an IO block 114 and one or more Start Sync Finite State Machine(s) (FSM(s)) 116 having multiple states 117. IO block 114 includes a pair of serializers 118 and 120 with skew, three deserializers 122, 124, and 126 with deskew, and an IO PLL 128. Start Sync FSM(s) 116 produce an output that is used as clock enable signal 130 that is transferred from FPGA 104 to PE ASIC 108 over a serial peripheral interface (SPI).

Test module 100 further shows various clock and control signals, including a system main clock (MnClk) signal 132 that is provided as an input to clocking/DSS block 106. In turn, clocking/DSS block 106 provides output signals including a full rate clock 134, GCDs 136 and 138, a RefClk 140, DDS/clock controls 142, and a MnClk 144. Serializers 118 and 120 respectively provide a receive direction signal 146 and a data transmit (Tx) signal 148 to PE ASIC 108, while PE ASIC 108 outputs a DUT compare result signal 150 that is provided as an input to deserializer 122.

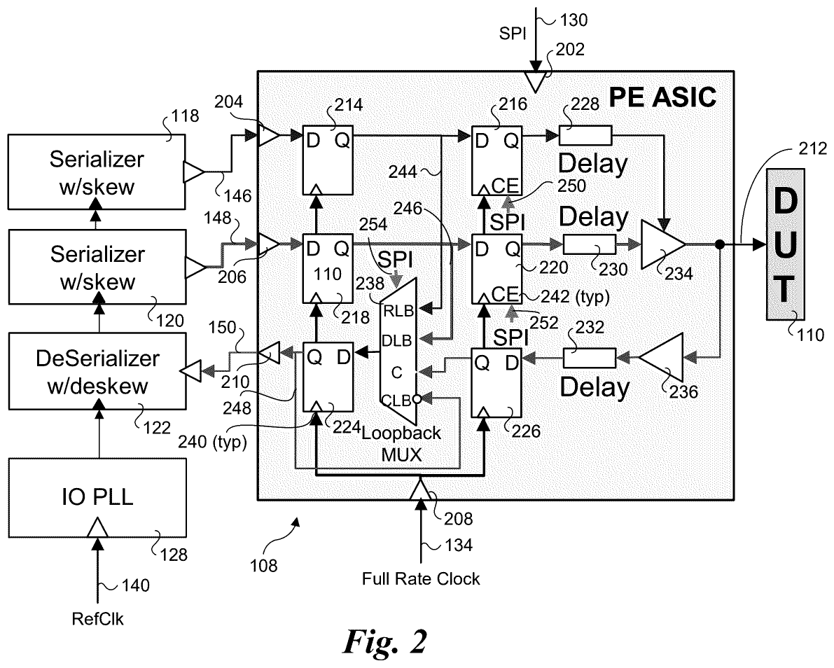

FIG. 2 shows further details of selected components of FIG. 1, including PE ASIC 108, according to one embodiment. PE ASIC 108 includes four input ports/interface 202, 204, 206, and 208, an output ports/interfaces 210 and an IO interface 212. PE ASIC 108 also includes six D flip-flops 214, 216, 218, 220, 224, and 226, delays 228, 230, and 232, amplifiers 234 and 236, and a mux 238. Each of D flip-flops 214, 218, 224, and 226 include a clock input 240. Each of d flip-flops 216 and 220 further include a clock enable (CE) input 242.

Receive direction signal 146 signal 146 comprises an IO direction signal that is used to control the direction of data transmitted or received over IO interface 212. Data transmit signal 148 comprises data to be transmitted over IO interface 212 to DUT 110.

For simplicity, IO interface 212 is shown as a single line. In practice, this IO interface supports IO signals that are used to communicate with DUT 110, and may comprise one or more channels and/or one of more types of ports/interfaces (per PE ASIC), potentially employing different communication protocols.

The circuitry in PE ASIC 108 is configured to support multiple loopback signals. These include a Receive/Direction loopback (RLB) over SPI, as depicted by an RLB signal 244 and an RLB input for mux 238, a Data loopback (DLB) over SPI, as depicted by a DLB signal 246 and DLB input for mux 238, and a compare toggle loopback (CLB), as depicted by a CLB signal 248 and a CLB input for mux 238.

Clock enable signal 130 is received at input port/interface 202, which comprises an SPI interface. Clock enable signal 130 is internally routed over SPI to CE inputs for D flip flops 216 and 220, as depicted by SPI arrows 250 and 252. Clock enable signal 130 is also internally routed over SPI to provide a clock enable input to mux 238, as depicted by an SPI arrow 254.

As shown in the lower portion of FIG. 2, full rate clock input 134 is provided at input interface 208 and received at the clock inputs for D flip-flops 224 and 226. The Q outputs of D flip-flops 224 and 226 provide input clock signals to D flip-flops 218 and 220. The D outputs of D flip-flops 218 and 220 the provide input clock signals to D flip-flops 214 and 216. The clocking sequence of these D flip-flops is thus cascaded in sequence (224→218→214 and 226→220→216). It is noted that D flip-flops 216 and 220 will not operate unless their CE inputs are set.

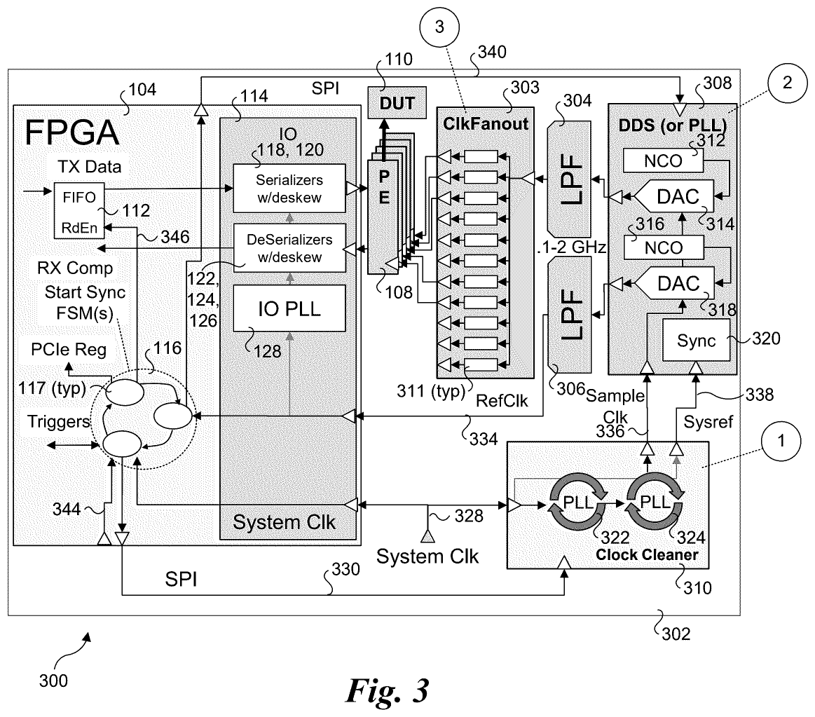

FIG. 3 shows a system diagram of a test module 300 illustrating additional details of test module 100. Test module 300 includes a board 302 to which various components and circuitry are mounted/integrated, including an FPGA 104, multiple PE ASICs 108, a clock fanout block 303, low pass filters (LPFs) 304 and 306, a DDS (or PLL) 308, and a clock cleaner 310. Clock fanout block 303 includes a plurality of divider/multiplexer (Div/Mux) blocks 311. DDS (or PLL) 308 may be a DSS or a PLL, and includes a Numerically Controlled Oscillator (NCO) 312, a Digital to Analog Convertor (DAC) 314, and NCO 316, a DAC 318, and a sync block 320. Clock cleaner 310 includes a pair of PLLs 322 and 324.

Additional new signals shown in test module 300 include a system clock input 328, a Start Sync FSM signal 330, a RefClk signal 334, a sample clock 336, a system reference (Sysref) signal 338, a Start Sync FSM signal 340, a sync event signal 344, and a FIFO Read Enable (RdEn) signal 346.

The overall hardware strategy to create high-performance (low jitter) clock is performed in three stages, as respectively depicted by encircled numbers ‘1’, ‘2’, and ‘3’ in FIG. 3. In some embodiments, the first stage in the clock path employs clock cleaner 310 to get excellent overall jitter performance. The second element/stage employs a DDS of PLL that can generate arbitrary frequencies and perform dynamic skew; this element/stage is implemented by DDS (or PLL) 308. The third stage is a clock fanout that creates enough total clocks to provide clean copies to all other devices in the signal path, such as provided by clock fanout block 303. In other embodiments, the clock cleaner stage is optional and when the clock cleaner stage is not used the stages referred to as second and third stages below comprise first and second stages.

FIG. 3a shows further details of the three-stage clock path. System clock 328 is received as an input to clock cleaner 310 which employs PLLs 322 and 324 to clean the system clock signal and output sample clock 336 and Sysref signal 338, which is received as an input to sync block 320. The output of DAC 314 is an analog signal having a sinusoidal waveform that passes through an amplifier 348 and LPF 304. This amplified and filtered analog signal is then received at a super high-gain amplifier 350, which provides an input to each of Div/Mux blocks 311. The output for each of Div/Mux block 311 is fed to a respective amplifier 354, which outputs a respective square-wave clock signal. In a similar manner, the output of DAC 318 passes through an amplifier 354 and LPF 306 to produce RefClk signal 334.

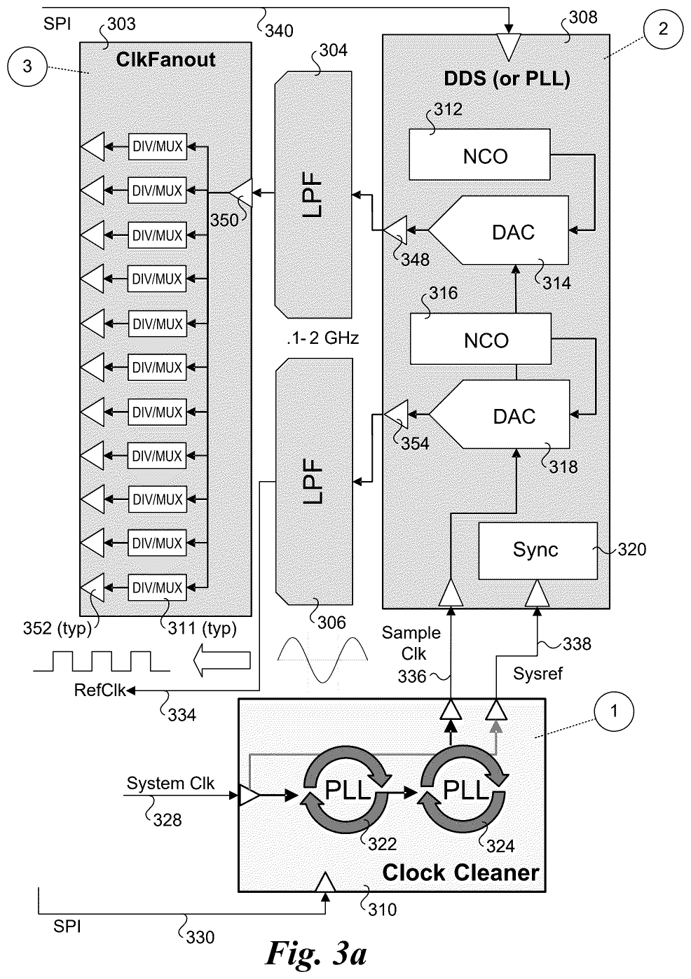

FIG. 4 shows a test system 400 including a tester 402 coupled to multiple test instruments comprising instances of test modules 300-1, 300-2, 300-3, and 300-4. Tester 402 includes a clock generator 404 which receives an oscillation input from a crystal 406 and processes the oscillation input using PLLs 408 and 410 to output a clock signal 412 that is received on the input side of a clock fanout block 414. Tester 402 further includes a PC blade 416 (e.g., server blade, server module, etc.) that hosts a software/user environment 418. Software running on PC blade 416 provides control/sync inputs to a central system FPGA 420 via a PCIe (Peripheral Component Interconnect Express) interface 422, which are used for sync/triggers 424.

Clock fanout block 414 is configured in a similar manner to clock fanout block 303 discussed above, and include a plurality of Div/Mux blocks 311. In this example, all the Div/Mux blocks 311 are configured the same to output a respective system clock 428, with each instance of system clock 428 being provided as the system clock input for each of test modules 300-1, 300-2, 300-3, and 300-4. In this non-limiting example, the system clocks are 125 MHz. Meanwhile, central system FPGA provides system events and triggers as system sync events 430 to the system sync event inputs for each of test modules 300-1, 300-2, 300-3, and 300-4.

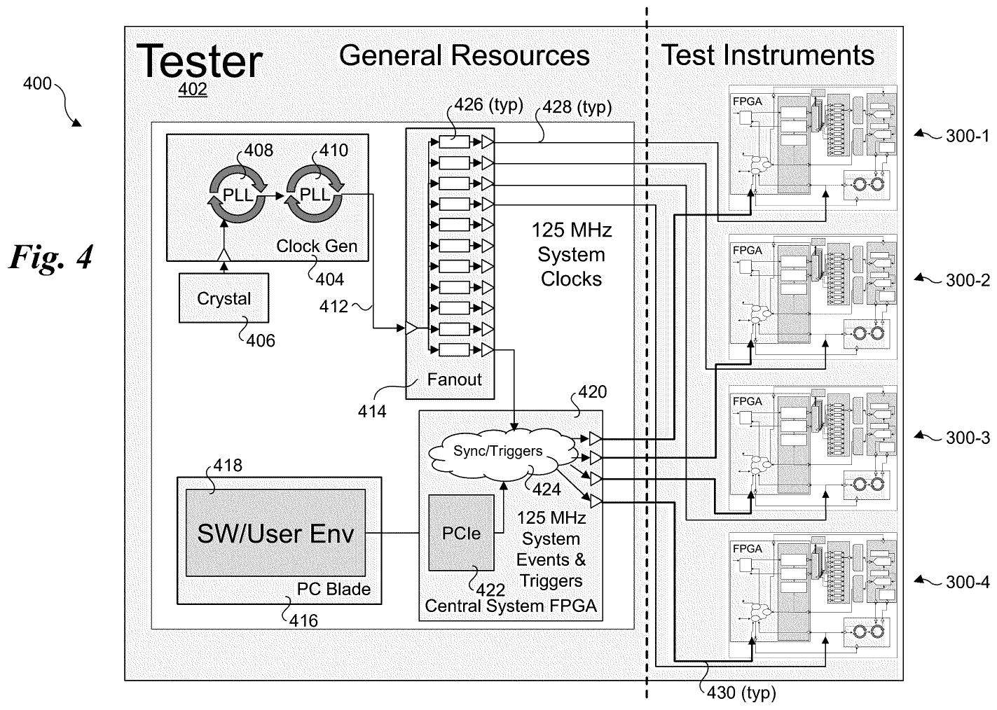

FIG. 5 shows some example signal routing/processing paths that are used for a plurality of test modules 300. Each of test modules 300 receives a respective system clock 428 and respective system sync event signals 430. As shown by a first path ‘1’, the system clock input is processed by clock cleaner 310, DDS (or PLL) 308, LPF 304, and clock fanout block 303, which outputs a RefClk 140 that is received by IO PLL 128. As shown by a second path ‘2’, a system sync event 430 is received as an input to FPGA 104 and is provided as a sync event signal 344 to Start Sync FSM(s) 116. This triggers one of the states in FSM(s) 116 to send a read enable signal 346 that is received at the RdEn input of FIFO 112. A third path ‘3’ shows the forwarding path of Start Sync FSM signal 340 from Start Sync FSM(s) 116 to DDS (or PLL) 308.

It should be observed that the first, second, and third paths are distinct paths that nominally would have different delays and pose difficulties in keeping the signals synchronized. However, under the embodiments herein, means are provided to keep the signals synchronized.

In one embodiment, Start Sync FSM(s) 116 have visibility to all domains and are used for the following. First, they are used to sequence all clock chip events. Second, they measure the DDS accumulator phase. Third, they are used to drive the training sequence at the IO/PE boundary. Fourth, they are used to control the frequency hopping of the DDS deterministically. In one embodiment, Start Sync FSM(s) do all the foregoing without any metastability/cycle slip indeterminism for members of the same domain.

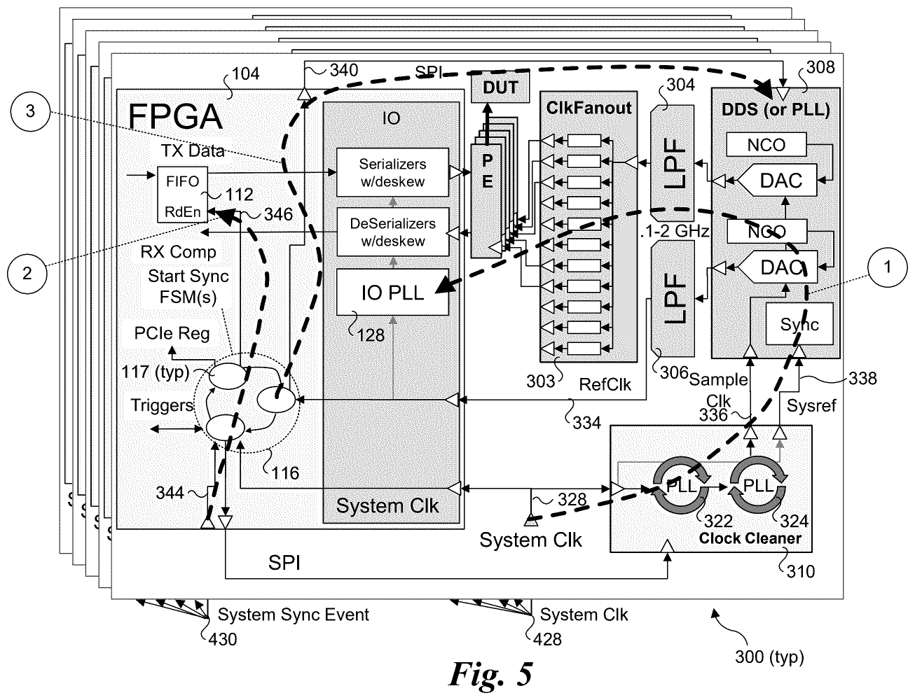

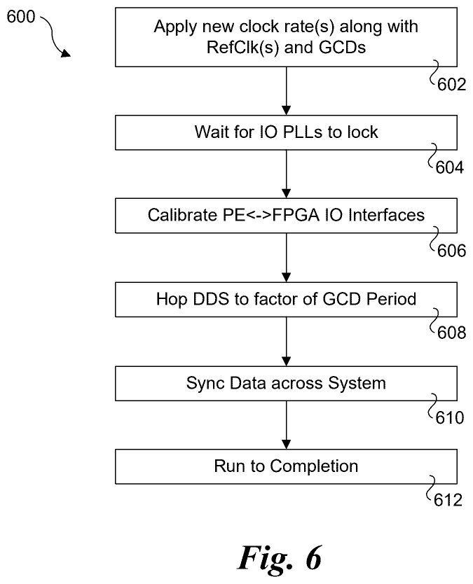

FIG. 6 shows a flowchart 600 illustrating operations performed to during a sync start sequence, according to one embodiment. The flow begins in a block 602 by applying new clock rate(s) along with RefClks and GCDs. In a block 604, the process waits for the IO PLLs to lock. Next, in a block 606, the PE↔FPGA IO interfaces are calibrated, as discussed in further detail below with reference to flowchart 700 in FIG. 7. In a block 608, DDS is hopped to a factor of the GDC period. Data is then synced across the system in a block 610, and the testing is run to completion in a block 612.

Flowchart 700 of FIG. 7 shows operations performed to calibrate the PE↔FPGA IO interfaces, according to one embodiment. In a block 702, the state on the DUT visible IOs is held be des-asserting clock enable (CE) inputs. In a block 704 the compare toggle loopback through SPI is enabled. An eye search is then performed using an FSM.

Next, the Receive/Direction loopback over SPI is enabled, as shown in a block 706. A TX (transmit) eye search is performed, followed by a latency search in FSM. In a block 708, the Data loopback over SPI is enabled. A TX eye search is performed, followed by a latency search in FSM.

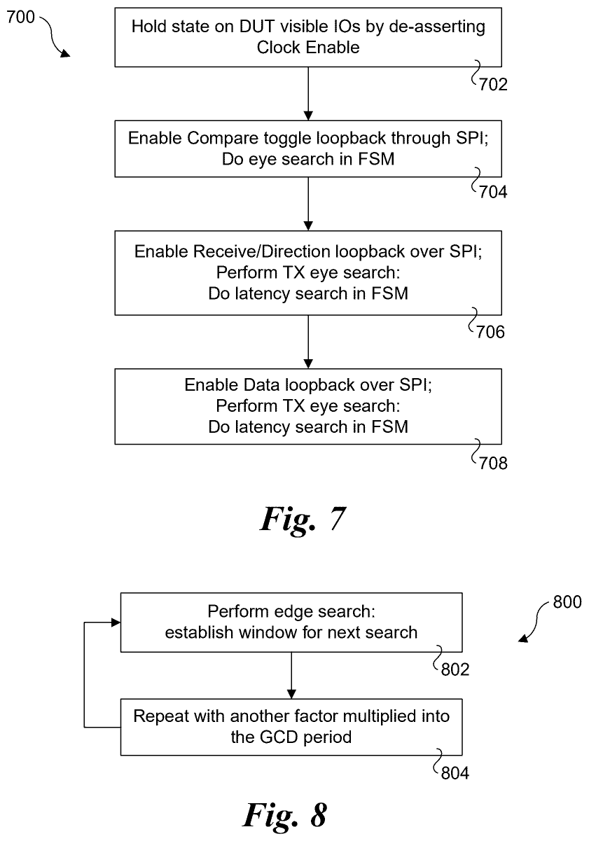

FIG. 8 shows a flowchart 800 illustrating operations performed to implement the DDS hop to a factor of the GCD period in block 608. In a block 802, an edge search is performed to establish a window for the next search. The operation of block 802 is then repeated with another factor multiplied into the GCD period, as shown in a block 804 and the loopback to block 802.

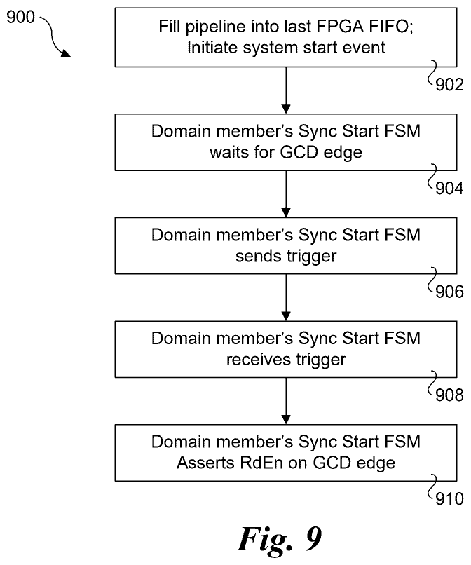

FIG. 9 shows a flowchart 800 illustrating operations performed to implement the data sync across the system operation of block 610. In a block 902 the pipeline into the last FPGA FIFO is filled, and a system start event is initiated. The domain member's Sync Start FSM waits for a GCD edge, as shown in a block 904. The domain member's Sync Start FSM then sends a trigger in a block 906. The domain member's Sync Start FSM receives the trigger in a block 908, and the domain member's Sync Start FSM asserts a RdEn on the GCD edge in a block 910.

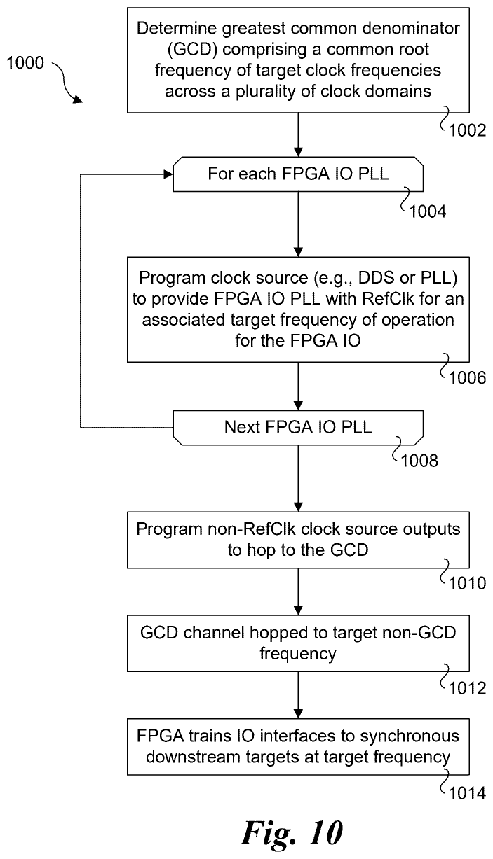

FIG. 10 shows a flowchart 1000 illustrating operations used to program and train various clock signals. In a block 1002, the GCD comprising a common root frequency of the target clock frequencies across a plurality of clock domains is determined. Next, as shown by a loop including start and end loop blocks 1004 and 1008, the operation of a block 1006 is performed for each FPGA IO PLL. In block 1006 the clock source is programmed to provide the FPGA IO PLL with a RefClk for an associated target frequency of operation for the FPGA IO.

Next, in a block 1010 the non-RefClk clock source outputs are programmed to hop to the GCD. In a block 1012 the GCD channel is hopped to target the non-GCD frequency. The FPGA then trains the IO interfaces to synchronous downstream targets at the target frequency in a block 1014.

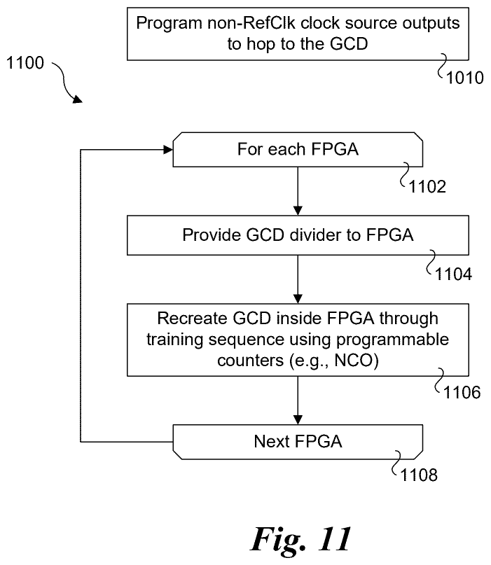

FIG. 11 shows a flowchart 1100 illustrating further details for programming the non-RefClk clock source outputs to hop to the GCD from block 1010 above. As shown by the start and end loop blocks 1102 and 1108, the operations of blocks 1104 and 1106 are performed for each FPGA. In block 1104 the GCD divider is provided to the FPGA. In block 1106, the GCD is recreated inside the FPGA through a training sequence using programmable counters, such as but not limited to an NCO.

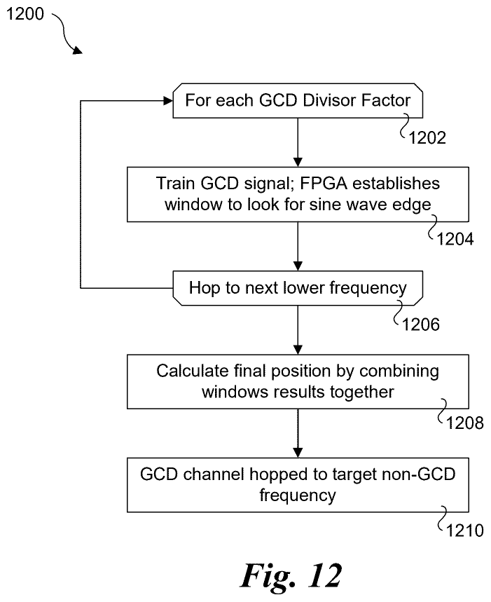

FIG. 12 shows a flowchart 1200 illustrating operations to obtain a GCD signal. The flow begins in a first iteration of a start loop block 1202 for a first (current) GCD divisor factor, which will be the highest GCD divisor factor. In a block 1204 the GCD signal is trained (for the current divisor factor), with the FPGA establishing a window to look for a sine wave edge. The flow proceeds to an end loop block 1206 where the frequency is hoped to a next lower frequency (based on the next highest GCD divider factor), followed by the flow looping back to start loop block 1202, using the next highest GCD divider factor as the current GCD divider factor. Once the GCD is trained for each of these GCD divisor factor frequencies, the flow proceeds to a block 1208 in which the final position of the window is calculated by combining the windows results together. The GCD channel is then hopped to a target non-GCD frequency.

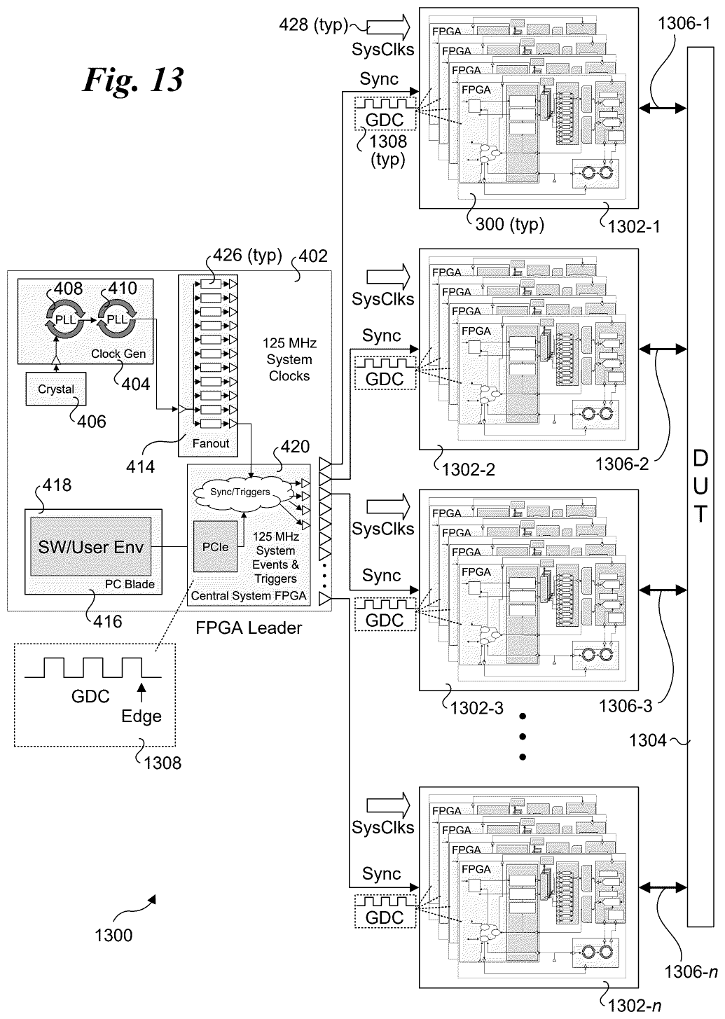

FIG. 13 shows a test system 1300, according to one embodiment. Test system 1300 further expands what is shown in test system 400 of FIG. 4, and includes tester 402 and n test instrument boards 1302-1, 1302-2, 1302-3 . . . 1302-n. Each instrument board 1302 includes four instances of test modules 300, wherein four instances is exemplary and non-limiting. Each of the n instrument boards 1302-1, 1302-2, 1302-3 . . . 1302-n is connected in communication with a DUT over respective IO interfaces 1306-1, 1306-2, 1306-3 1306-n, which are depicted as double-headed arrows for simplicity. A given IO interface 1306 may comprise many sets of IO interfaces and comprise (during operation) clock signals and data and control signals operating at multiple clock frequencies in multiple clock domains. As before, the IO interfaces may also comprise different types of IO interfaces using different communication protocols.

Central system FPGA operates as an FPGA leader and provides a GCD sync signal 1308 to each of test modules 300. In one embodiment, tester 402 and instrument boards 1302-1, 1302-2, 1302-3 . . . 1302-n include edge connectors and are installed in a chassis or the like that includes a base plane (aka base board) or backplane having multiple mating connectors in which the board edge connectors are installed. Optionally, other types of mating connectors or cabling may be used. The connectors and base plane or backplane include electric paths (e.g., wiring in a printed circuit board (PCB) for multiple instances of the GCD sync signals. In some embodiments, there will be separate electric paths for each instance of the GCD sync signals (e.g., four electrical paths for each of test modules 300). Under an alternative approach, a single GCD sync signal is provided to an instrument board 1302 that has an internal means for creating a replicated GCD sync signal for each test module 300. Preferably, the routing of the electrical paths in the base plane or backplane are configured such that the propagation delay of the GDC sync signals match.

As with test system 400 in FIG. 4, a 125 MHz system clock signal will likewise be provided to each of test modules 300 as the system clock inputs 428 for those test modules, as depicted by SysClk signals 428. The routing of individual SysClk signals is not shown in FIG. 13 for simplicity and to avoid clutter.

As illustrated, an edge of the GCD signals 1308 is used to sync the timing across the clock domains for the IO circuitry in each test modules 300. This is similar to the GCD sync process describe and illustrated above in FIG. 4, except in FIG. 13 the GCD signals 1308 are received at instrument boards 1302-1, 1302-2, 1302-3 . . . 1302-n and distributed internally to the test modules 300 on each instrument board.

In the foregoing description and Figures, FPGAs are used. As an alternative, the functionality described and illustrated for the FPGAs may be implemented using an ASIC; thus for one or more embodiments in which a FPGA is illustrated and described, an ASIC may be substituted for the FPGA. While PE ASICs are described and illustrated in the embodiments above, more generally the circuitry described and illustrated for a PE ASIC comprises a PE block. Moreover, one or more PE blocks may be implemented on a single ASIC, in some embodiments.

Generally, the PE ASICs describe and illustrated herein comprise synchronous devices, and thus in some embodiments other types of synchronous devices may be used in place of the PE ASICS. For example, such synchronous devices may be used in various types of equipment requiring synchronization of many signals, such as but not limited to radar equipment, logic analyzers, oscilloscopes, or systems where tight phase sampling is required.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘n’ in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus, comprising:
a Field Programmable Gate Array (FPGA) or Application Specific Integrated Circuit (ASIC) having a target frequency of operation for input-out (IO) signals;
programmable clock generation circuitry to generate a plurality of programmable clock signals including a reference clock (RefClk) signal that is correct for the target frequency of operation of IO signals; and
a plurality of synchronous devices, each synchronous device to,
receive a respective clock signal output from the programmable clock generation circuitry; and
generate and receive a respective set of IO signals associated with a respective clock domain,
wherein the respective sets of IO signals generated and received by the plurality of synchronous devices are synchronized across the respective clock domains.

2. The apparatus of claim 1, wherein the programmable clock generation circuitry comprises a multi-stage clock path, including:
a first stage configured to receive a system clock signal and generate arbitrary programmable frequencies; and
a second stage comprising a clock fanout that receives input from the second stage and outputs clean copies of clock signals having at least two different frequencies and including the RefClk signal.

3. The apparatus of claim 2, wherein the first stage outputs greatest common denominator (GCD) clock signal having a frequency that is a greatest common denominator of the different frequencies of the clock signals output by the second stage, and wherein the GCD clock signal is provided as an input to the FPGA or ASIC.

4. The apparatus of claim 1, wherein the second stage comprises a direct digital synthesis (DDS) chip or circuit, and the apparatus further comprises an interface to enable software running on a computing device coupled to the apparatus to program the DDS chip or circuit.

5. The apparatus of claim 1, wherein the FPGA or ASIC includes an IO block having an IO phase-lock loop (PLL) that receives the RefClk signal as an input.

6. The apparatus of claim 1, wherein the plurality of synchronous devices comprises a plurality of pin electronic (PE) blocks.

7. The apparatus of claim 6, wherein a PE block includes an output that is coupled to an input of the IO block and at least one input that is coupled to at least one output of the IO block.

8. The apparatus of claim 6, wherein the respective sets of IO signals generated and received by the plurality of PE block are configured to be utilized as IO signals for a device under test (DUT) operating at a plurality of clock domains, wherein the IO signals for the DUT are synchronized across the plurality of clock domains.

9. The apparatus of claim 1, wherein the FPGA or ASIC includes one or more finite state machines (FSMs) that are configured to receive one or more external sync signals and generate the sync signals provided to the plurality of PE blocks.

10. The apparatus of claim 1, further comprising multiple instances of circuitry, each comprising:
an FPGA or Application ASIC having a target frequency of operation for IO signals;
programmable clock generation circuitry to generate a plurality of programmable clock signals including a RefClk signal that is correct for the target frequency of operation of IO signals for the FPGA or ASIC; and
a plurality of synchronous devices, each synchronous device to,
receive a respective clock signal output from the programmable clock generation circuitry; and
generate and receive a respective set of IO signals,
wherein, for each instance of circuitry, the FPGA or ASIC is configured to provide a sync signal to each of the plurality of PE blocks, and the respective sets of IO signals generated and received by the plurality of PE blocks are synchronized across the PE blocks,
and wherein the respective IO signals generated and received by the plurality of PE blocks for the multiple instances of circuitry are synchronized.

11. A method for synchronizing clocks across a plurality of clock domains, comprising:
determining a greatest common denominator (GCD) comprising a common root frequency of target clock frequencies across the plurality of clock domains;
programming clock generation circuitry to provide, for each of a plurality of Field Programmable Gate Arrays (FPGAs) or Application Specific Integrated Circuits (ASICs), a reference clock (RefClk) signal that is correct for an associated target frequency of operation of input-output (IO) signals for that FPGA or ASIC;
generating a plurality of IO signals including clock signals having the target frequencies; and
synchronizing the plurality of IO signals.

12. The method of claim 11, wherein there are one or more instances of clock generation circuitry comprising a multi-stage clock path, including,
a first stage receiving a system clock signal and generating arbitrary programmable frequencies; and
a second stage comprising a clock fanout receiving input from the second stage and outputting clean copies of respective clock signals,
wherein the second stage of the one or more instances of the clock generation circuitry provides the RefClk signals to the plurality of FPGAs or ASICs.

13. The method of claim 11, further comprising:
providing replicated system clock signals to a plurality of boards, each board having one or more instances of the clock generation circuitry and generating a respective plurality of IO signals;
providing a synchronization signal to each of the plurality of boards; and
employing, at each board, the system clock signal and the synchronization signal to synchronize the plurality of IO signals for that board,
wherein the pluralities of IO signals for all the boards are synchronized across a plurality of clock domains.

14. The method of claim 11, further comprising:
for each of a plurality of GCD division factors, starting with a highest GCD division factor comprising an initial current GCD division factor,
a) train a clock signal having a frequency associated with a current GCD division factor;
b) hop to a next lower GCD division factor; and
c) return to a) using the next lower GCD division factor as a new current GCD division factor.

15. The method of claim 11, wherein the FPGA or ASIC is implemented on a board including one or more pin electronic (PE) blocks, further comprising:
tuning an interface between the FPGA or ASIC and each of the one or more PE blocks.

16. A system comprising:
a plurality of boards communicatively coupled in communication, including,
a central system board; and
a plurality of instrumentation boards, each instrumentation board comprising,
a Field Programmable Gate Array (FPGA) or Application Specific Integrated Circuit (ASIC) having a target frequency of operation for input-out (IO) signals;
programmable clock generation circuitry to generate a plurality of programmable clock signals including a reference clock (RefClk) signal that is correct for the target frequency of operation of the IO signals; and
a plurality of pin electronic (PE) blocks, each PE block to,
receive a respective clock signal output from the programmable clock generation circuitry; and
generate and receive a respective set of IO signals associated with a respective clock domain,
wherein the respective sets of IO signals generated and received by the plurality of PE blocks are synchronized across the respective clock domains, and
wherein the central system board is configured to transmit a system clock signal and a sync signal to each of the plurality of instrument boards, wherein the sync signal is used to sync IO operation across the plurality of instrument boards.

17. The system of claim 16, wherein an instrument board includes multiple instances of the FPGA or ASIC, the programmable clock circuitry, and the plurality of PE blocks, and wherein the clock domains are synchronized for IO operations across all clock domains implemented for the multiple instances.

18. The system of claim 16, wherein the programmable clock generation circuitry comprises a multi-stage clock path, including:
a first stage comprising a clock cleaner to clean an input system clock signal;
a second stage configured to receive an output from the clock cleaner and generate arbitrary programmable frequencies; and
a third stage comprising a clock fanout that receives input from the second stage and outputs clean copies of clock signals having at least two different frequencies and including the RefClk signal.

19. The system of claim 16, wherein the central system board includes embedded logic to:
determine frequencies of the clock domains to be implemented across the system; and
determine a greatest common denominator (GCD) of the clock domain frequencies,
wherein the sync signal has a frequency corresponding to the GCD.

20. The system of claim 16, wherein the system comprises a Device Under Test (DUT) tester and wherein the IO signals for the PE blocks across the system are connected to at least one of a board in which a DUT is installed and the DUT.
